(19) United States
(12) Patent Application Publication
(10) Pub. No.: US 2010/0207825 A1
(43) Pub. Date: Aug. 19, 2010

(54) MOBILE TERMINAL AND ANTENNA APPARATUS THEREFOR

(75) Inventors: Gang Yan, Beijing (CN); Heng Luo, Beijing (CN)

Correspondence Address: SCHWEGMAN, LUNDBERG & WOESSNER, P.A., P.O. BOX 2938, MINNEAPOLIS, MN, 55402, US

(73) Assignee: Lenovo (Beijing) Limited, Beijing (CN)

(21) Appl. No.: 12/703,852

(22) Filed: Feb. 11, 2010

(30) Foreign Application Priority Data
Feb. 13, 2009 (CN) 200910077483.4

(51) Int. Cl. H01Q 9/04; H01Q 1/24

(52) U.S. Cl. 343/702; 343/700 MS

(57) ABSTRACT

A mobile terminal and an antenna apparatus therefor are provided. The antenna apparatus comprises an antenna body arranged at a first position in a space between the display case and the display screen; and a reference ground connected to the antenna body and arranged at a second position in the space, the reference ground having an electromagnetic band gap structure. With such a structure, it is possible to effectively improve the radiation efficiency of the antenna without increasing the size of the antenna apparatus. Thus, the antenna apparatus can satisfy the design requirement on portability of the mobile terminal.

### TECHNICAL FIELD

The present invention relates to the field of basic electrical elements, and more particularly, to a mobile terminal and an antenna apparatus therefor.

### BACKGROUND

At present, in order to satisfy user requirements on portability of mobile terminals, the mobile terminals are increasingly miniaturized. For example, in designing a notebook computer, a designer, taking the user requirements on portability into consideration, tends to make its dimension smaller, such that the space for mounting an antenna along an edge of its screen and housing becomes smaller. When the space for mounting an antenna is smaller than 60 mm (length)×5 mm (width)×8 mm (height), it is extremely difficult to implement a 3G antenna operating at 900/1800 MHz and having a bandwidth coverage of 824-960 MHz and 1720-2170 MHz with a conventional antenna design. In particular, the antenna will have a narrow bandwidth, a large in-band echo loss and a low feed efficiency.

The smaller the size of the antenna is, the lower the radiation efficiency of the antenna will be. As a result, the antenna efficiency, which is a product of the feed efficiency and the radiation efficiency, is further degraded in the case where the bandwidth is insufficient and the feed efficiency is low.

In implementing the present invention, at least the following problem in prior art has been found. In prior art, the radiation efficiency of an antenna is generally improved by increasing the dimension of the antenna, which directly affects the overall dimension of a mobile terminal having the antenna mounted therein.

### SUMMARY

In view of the above problem, the present invention is made. An object of embodiments of the present invention is to provide a mobile terminal and an antenna apparatus therefor, by which it is possible to effectively improve the radiation efficiency of the antenna without increasing the dimension of the antenna apparatus.

To achieve the above object, according to an embodiment of the present invention, an antenna apparatus for a mobile terminal which comprises a display case and a display screen is provided, comprising:

an antenna body arranged at a first position in a space between the display case and the display screen; and

a reference ground connected to the antenna body and arranged at a second position in the space, the reference ground having an electromagnetic band gap structure.

Preferably, the antenna apparatus further comprises a co-axial feed line comprising an inner conductor connected to the antenna body and an outer conductor connected to the reference ground.

Preferably, the antenna body comprises a planar inverted F antenna (PIFA).

Preferably, the electromagnetic band gap structure comprises a periodic planar structure with slits, the periodic planar structure being composed of a plurality of triangular patches.

Preferably, the triangular patches each have a through hole arranged therein.

According to an embodiment of the present invention, a mobile terminal is provided, comprising:

a display comprising a display case and a display screen; and

an antenna apparatus arranged between the display case and the display screen, wherein the antenna apparatus comprises:
an antenna body arranged at a first position in a space between the display case and the display screen; and
a reference ground connected to the antenna body and arranged at a second position in the space, the reference ground having an electromagnetic band gap structure.

Preferably, the antenna apparatus further comprises a co-axial feed line comprising an inner conductor connected to the antenna body and an outer conductor connected to the reference ground.

Preferably, the antenna body comprises a planar inverted-F antenna (PIFA).

Preferably, the electromagnetic band gap structure comprises a periodic planar structure with slits, the periodic planar structure being composed of a plurality of triangular patches.

At least one of the above solutions has the following advantageous effects. The reference ground of the antenna apparatus may be arranged in an Electromagnetic Band Gap (EBG) structure, and the antenna body of the antenna apparatus is arranged in a mounting space which is different from that for the reference ground, such that the radiation efficiency of the antenna can be effectively improved without increasing the dimension of the antenna apparatus. Thus, the antenna apparatus can satisfy the design requirement on portability of the mobile terminal.

### BRIEF DESCRIPTION OF THE DRAWINGS

FIG. 1 is a schematic perspective view showing an antenna apparatus according to an embodiment of the present invention.

FIG. 2 is a plan view showing an antenna body according to an embodiment of the present invention.

FIG. 3 is a schematic diagram showing the structure of a reference ground according to an embodiment of the present invention.

FIG. 4 is a schematic diagram showing the periodic structure of FIG. 3.

FIG. 5 is a schematic assembly diagram in which an antenna apparatus is mounted in a mobile terminal according to an embodiment of the present invention.

FIG. 6 is a schematic diagram showing a test result for a sample according to an embodiment of the present invention.

### DETAILED DESCRIPTION OF THE PREFERRED EMBODIMENTS

The above and other objects, solutions and advantages of the present invention become more apparent by reading the following detailed descriptions on embodiments of the present invention with reference to the drawings. It should be noted that the embodiments are provided here for illustration, rather than limitation, of the present invention.

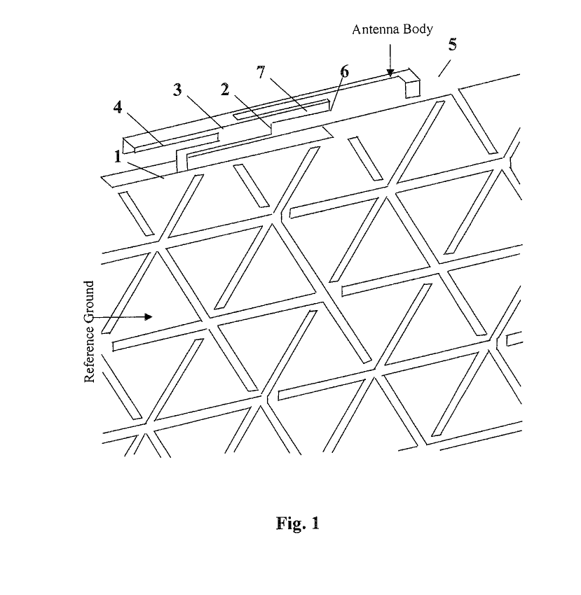

Referring to FIG. 1, a schematic perspective view of an antenna apparatus incorporated into a mobile terminal according to an embodiment of the present invention is shown. The mobile terminal comprises a display case (not shown), a display screen (not shown) and the antenna apparatus. The antenna apparatus comprises an antenna body and a reference ground. In this embodiment, the antenna body may be arranged at a first position in a space between the display case and the display screen, and the reference ground may be arranged at a second position in the space which is different from the first position. In addition, the reference ground may be provided as an electromagnetic band gap (EBG) structure and is connected to the antenna body. In this embodiment, the position of the antenna body with respect to the reference ground may be determined based on the size of the space for mounting the antenna apparatus or other factors. For example, the antenna body may be arranged on one side or both sides of the reference ground. Or otherwise, the antenna body may be arranged surrounding the reference ground. FIG. 1 only illustrates a case where the antenna body is arranged on one side of the reference ground. In this way, the reference ground with the electromagnetic band gap structure can confine an induced current of the antenna body in the proximity of the antenna body, such that the resistive loss can be reduced and the radiation efficiency of the antenna can be improved.

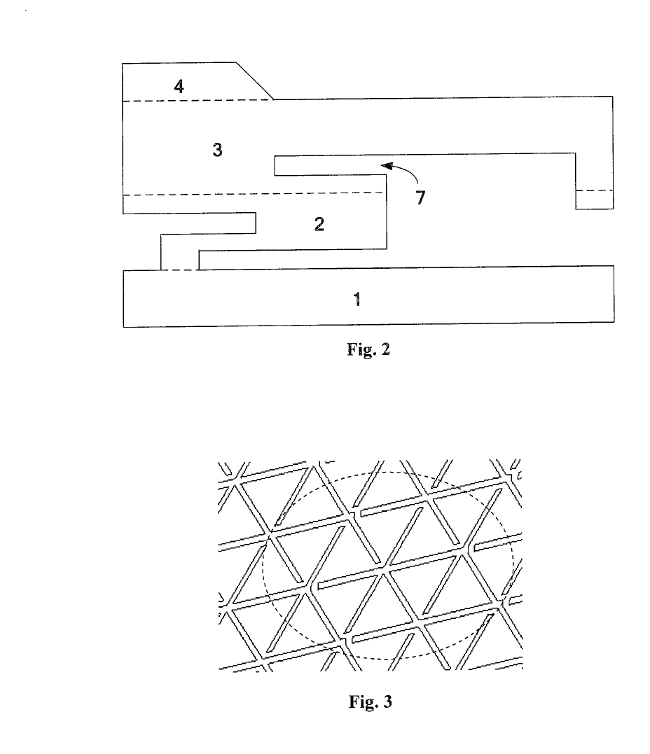

Referring to FIGS. 1 and 2, the antenna body comprises four antenna units, 1, 2, 3 and 4. For the purpose of description, the following explanation will be made taking the shapes of the respective antenna units shown in FIG. 2 as example, which is not intended to limit the present invention. As shown in FIG. 2, the antenna unit 1 is arranged to be rectangular and the antenna unit 2 is arranged to be a T-shape. Further, the lower end of the T-shaped antenna unit 2 is bent to be a ‘r’ shape (as shown in FIG. 2) and connected to the antenna unit 1. The antenna unit 3 has a slit 7 arranged thereon, which separates a resonance branch 5 and a resonance branch 6 having different lengths on the antenna unit 3, as shown in FIG. 1. The end of the resonance branch 5 may be extended and bent. Moreover, the antenna unit 4 has one edge connected to the antenna unit 3, and may be rectangular or triangular in shape. In this embodiment, the antenna units 1-4 may be bent along dash lines shown in FIG. 2 to form the antenna body as shown in FIG. 1.

In this embodiment, the connections among the antenna units 1-4 may be made by welding, bolt fastening, or the like. Or otherwise, the antenna units 1-4 may be formed in one-piece, as shown in FIG. 2. In the latter case, the antenna body shown in FIG. 1 is obtained by simply bending the antenna units along the dash lines shown in FIG. 2. Other processes for the antenna body are the same as those for the existing antenna bodies, and thus are omitted here. Additionally, the material for the antenna units 1-4 may comprise copper, tin or another conductive metal. If the antenna units 1-4 are made of tin, it is possible to significantly reduce the manufacture cost for the antenna while satisfying the user requirement on antenna efficiency.

Referring back to FIG. 1, a case where the bent antenna body is fixed on one side of the reference ground is shown. In this case, one edge of the antenna unit 1 is connected to one edge of the reference ground in a superimposed manner. The antenna unit 2 may form an angle of 90 degrees with respect to the reference ground, and thus also forms an angle of 90 degrees with respect to the antenna unit 1. Of course, the angle between the antenna units 1 and 2 can be arranged otherwise. When the antenna unit 2 forms an angle of 90 degrees with respect to the reference ground, the bent antenna units 4 and 2 may be parallel with each other.

The specific shape of the antenna body as well as the connections among the respective antenna units of the antenna body are not limited to those described above. Rather, the specific shape of the antenna body may be designed according to actual implementations.

FIG. 3 is a schematic diagram showing the structure of the reference ground according to an embodiment of the present invention. In this embodiment, the reference ground has an electromagnetic band gap structure which comprises a periodic planar structure with slits, the periodic planar structure being composed of a plurality of triangular patches. For example, one period of the periodic planar structure may be composed of 8 triangular patches, as shown in a portion circled by the dashed line in FIG. 3. Of course, the structure is not limited thereto. The following explanation will be made taking the triangular patches as example. However, the patches may be formed in rectangular or other shapes.

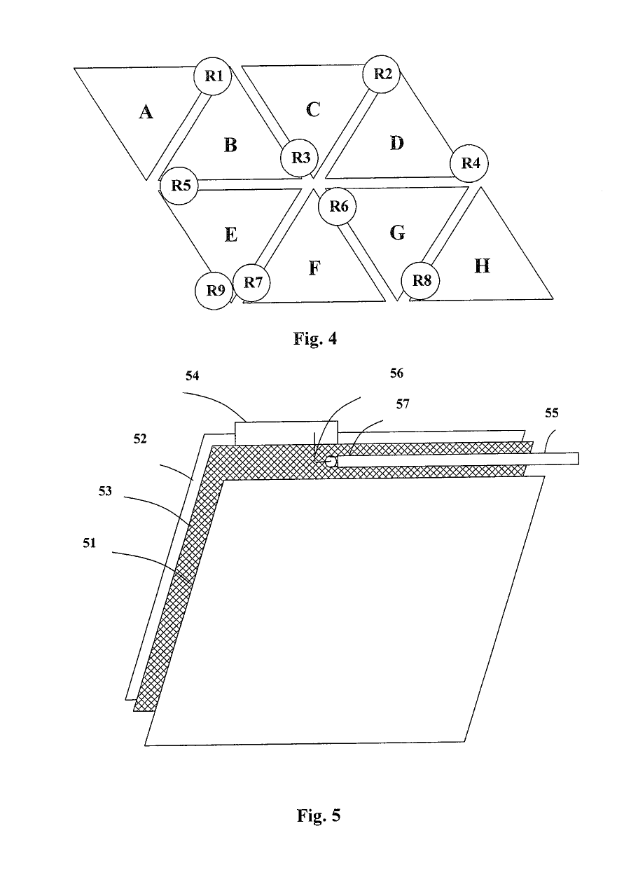

FIG. 4 is a schematic diagram showing one period of the periodic structure of FIG. 3. The period comprises 8 triangular patches, which are designated as patch A, patch B, patch C, patch D, patch E, patch F, patch G and patch H, respectively, for the purpose of description. The patch A is connected to the patch B through a connector R1. The patch B is connected to the patches A, C and E through connectors R1, R3 and R5, respectively. The patch C is connected to the patches D and B through connectors R2 and R3, respectively. The patch D is connected to the patch C through the connector R2 and to another adjacent patch through a connector R4. The patch E is connected to the patches B and F through connectors R5 and R7, respectively, and to another adjacent patch through a connector R9. The patch F is connected to the patches G and E through connectors R6 and R7, respectively. The patch G is connected to the patches F and H through connectors R6 and R8, respectively. The patch H is connected to the patch G through the connector R8. In this way, the above patches and connectors form one complete period of the periodic planar structure.

According to this embodiment, one complete period of the reference ground is composed of 8 triangular patches. Of course, the structure is not limited to this. The number of periods included in the reference ground may be determined according to actual implementations. For example, one or more complete period may be adopted. The number of the complete periods may be determined based on the space for mounting the antenna apparatus; or may be reduced as appropriate if the requirement on the radiation efficiency of the antenna is satisfied.

Also, a through hole may be arranged in each patch to achieve higher antenna efficiency. For example, the through hole may be arranged at the center of each patch.

The number of the complete periods is not limited for the reference ground in this embodiment. However, according to the characteristics of the electromagnetic band gap structure, it is better that the reference ground is composed of two or more complete periods.

Referring to FIG. 5, a schematic assembly diagram in which the antenna apparatus is mounted in the mobile terminal according to an embodiment of the present invention is shown. The mobile terminal comprises a display and an antenna apparatus. The display comprises a display screen 51 and a display case 52. The antenna apparatus may be arranged between the display case 52 and the display screen 51. The antenna apparatus comprises an antenna body 54 and a reference ground 53. The antenna body 54 is arranged at a first position in a space between the display case 52 and the display screen 51, and the reference ground 53 is arranged at a second position in the space between the display case 52 and the display screen 51 which is different from the first position.

In this embodiment, the antenna apparatus further comprises a co-axial feed line 55 including an inner conductor 56 connected to the antenna body 54 and an outer conductor 57 connected to the reference ground 53.

According to an implementation of the present invention, the antenna body 54 may comprise a planar inverted F antenna (PIFA). The reference ground 53 may be arranged to be parallel to the display screen 51 with a gap therebetween of 1-2 mm. The reference ground 53 can confine the ground induced current of the antenna body 54 in the proximity of the antenna body 54, unlike a metallic plate ground which would widely distribute the induced current over the entire plate. That is, the propagation of a surface wave, caused by the near filed of the antenna, along the reference ground 53 can be avoided by using the reference ground 53 with a periodic structure, such that the loss of the surface wave during propagation in the display or other lossy materials such as plastic can be reduced and thus the radiation efficiency of the antenna can be improved.

It has been indicated by test results that, at the frequency of 880 MHz, the antenna efficiency of the antenna apparatus without the periodic reference ground is 45%, while the antenna efficiency of the antenna apparatus having the structure according to this embodiment is 49.8%. An improvement by 4.8% in antenna efficiency is a significant progress in the antenna industry for mobile terminals. Moreover, this method for improving the radiation efficiency widely applies to planes with limited areas. For example, for current notebook computers with small sizes, such a structure according to the present invention has a particularly significant effect at the GSM band (824-960 MHz).

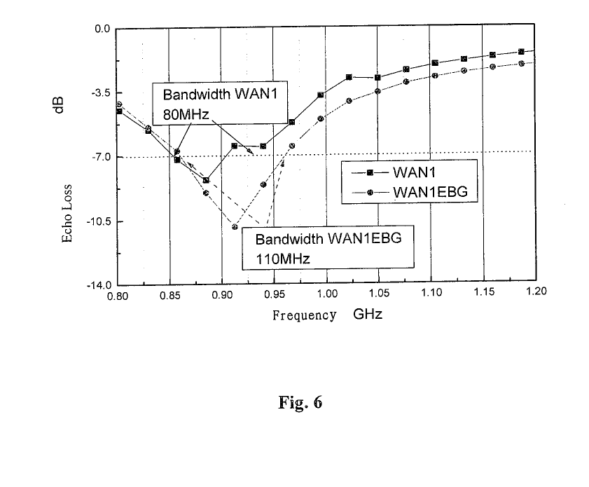

Referring to FIG. 6, a schematic diagram showing a test result for a sample device according to an embodiment of the present invention is shown. As shown, the WAN1 profile refers to the echo loss vs. frequency without the antenna apparatus according to this embodiment, and the WAN1EBG profile refers to the echo loss vs. frequency with the antenna apparatus according to this embodiment. In FIG. 6, the above two profiles are compared with respect to the intervals where the echo loss is lower than −7 dB. It can be seen that, when the echo loss is lower than −7 dB, the abscissa (frequency) ranges from 0.86 GHz to 0.96 GHz for the WAN1EBG profile while from 0.855 GHz to 0.92 GHz for the WAN1 profile. Thus, with the antenna apparatus according to this embodiment, the bandwidth for which the echo loss is lower than −7 dB is significantly extended, and the minimum echo loss actually achieved within the frequency range between 0.855 GHz and 0.92 GHz is much lower than −7 dB. As shown, the minimum echo loss for the WAN1EBG profile can be as low as −11 dB while the minimum echo loss for the WAN1 profile is −8 dB. The antenna efficiency of the antenna apparatus can be effectively improved as the WAN1EBG profile increases the bandwidth for which the echo loss is lower than −7 dB and achieves lower echo loss.

The mobile terminal as described above may comprise, but not limited to, an Ultra Mobile Personal Computer (UMPC), a smart phone, a Personal Digital Assistant (PDA) and the like.

Although the present invention has been disclosed above with reference to the preferred embodiments, those skilled in the art can make modifications and variations to the embodiments without departing from the principle of the invention. These modifications and variations also fall into the scope of the present invention.

What is claimed is:

1. An antenna apparatus for a mobile terminal which comprises a display case and a display screen, comprising:
an antenna body arranged at a first position in a space between the display case and the display screen; and
a reference ground connected to the antenna body and arranged at a second position in the space, the reference ground having an electromagnetic band gap structure.

2. The antenna apparatus according to claim 1, further comprising a co-axial feed line comprising an inner conductor connected to the antenna body and an outer conductor connected to the reference ground.

3. The antenna apparatus according to claim 1, wherein the antenna body comprises a planar inverted F antenna (PIFA).

4. The antenna apparatus according to claim 1, wherein the electromagnetic band gap structure comprises a periodic planar structure with slits, the periodic planar structure being composed of a plurality of triangular patches.

5. The antenna apparatus according to claim 4, wherein the triangular patches each have a through hole arranged therein.

6. A mobile terminal, comprising:
a display comprising a display case and a display screen; and
an antenna apparatus arranged between the display case and the display screen, wherein the antenna apparatus comprises:
an antenna body arranged at a first position in a space between the display case and the display screen; and
a reference ground connected to the antenna body and arranged at a second position in the space, the reference ground having an electromagnetic band gap structure.

7. The mobile terminal according to claim 6, wherein the antenna apparatus further comprises a co-axial feed line comprising an inner conductor connected to the antenna body and an outer conductor connected to the reference ground.

8. The mobile terminal according to claim 6, wherein the antenna body comprises a planar inverted-F antenna (PIFA).

9. The mobile terminal according to claim 6, wherein the electromagnetic band gap structure comprises a periodic planar structure with slits, the periodic planar structure being composed of a plurality of triangular patches.
